(19) United States
(12) Patent Application Publication
(10) Pub. No.: US 2026/0171546 A1
(43) Pub. Date: Jun. 18, 2026

(54) HEAT MANAGEMENT SYSTEM, AND MANUFACTURING METHOD FOR HEAT MANAGEMENT SYSTEM

(71) Applicant: TOYOTA JIDOSHA KABUSHIKI KAISHA, Toyota-shi (JP)

(72) Inventor: Takashi SASADA, Toyota-shi (JP)

(73) Assignee: TOYOTA JIDOSHA KABUSHIKI KAISHA, Toyota-shi (JP)

(21) Appl. No.: 19/408,770

(22) Filed: Dec. 4, 2025

(30) Foreign Application Priority Data
Dec. 12, 2024 (JP) 2024-217501

(51) Int. Cl. H01M 10/6567; H01M 10/625

(52) U.S. Cl. CPC H01M 10/6567; H01M 10/625; H01M 2220/20

(57) ABSTRACT

A manufacturing method for a heat management system includes reducing a pressure of air in a first channel and a second channel included in the heat management system from a supply apparatus included in the heat management system in a state where no coolant is flowing through the first channel and the second channel. The first channel and the second channel are configured to flow the coolant inside. The manufacturing method includes adding the coolant to the supply apparatus such that the supply apparatus simultaneously supplies the coolant to both the first channel and the second channel that are reduced in pressure. A pressure higher than atmospheric pressure is applied to the coolant.

### CROSS-REFERENCE TO RELATED APPLICATION

This application claims priority to Japanese Patent Application No. 2024-217501 filed on Dec. 12, 2024. The disclosure of the above-identified application, including the specification, drawings, and claims, is incorporated by reference herein in its entirety.

### BACKGROUND

### 1. Technical Field

The disclosure relates to a heat management system and a manufacturing method for a heat management system.

### 2. Description of Related Art

Japanese Unexamined Patent Application Publication No. 2024-081902 (JP 2024-081902 A) describes a heat management system. The heat management system includes a channel and a pump. Refrigerant flows through the channel. The pump circulates refrigerant in a fluid circuit formed by the channel. In the fluid circuit, a temperature sensor, an inverter, a motor, a flow regulating valve, a heat exchanger, and a radiator are provided in this order downstream from the pump.

### SUMMARY

In a heat management system, for example, before shipment from a factory, coolant can be supplied to a channel in a state where no coolant has flowed yet. At this time, in a pump provided in the channel, coolant may flow in a reverse direction that is a direction opposite to a direction in which the pump flows coolant. When the coolant flows in the reverse direction in the pump, the impeller of a pump rotates in reverse. As a result, a counter electromotive force is generated in a motor circuit for the pump, and current flows through the elements in the pump, with the result that the pump may be damaged.

On the other hand, the heat management system in which many apparatuses for heat exchange are disposed may already have a complex channel configuration. For this reason, there is a request to avoid a further complex channel in order to reduce the above-described damage to the pump.

The disclosure provides a heat management system capable of reducing damage to a pump when coolant is supplied while suppressing the complexity of a channel for coolant.

An aspect of the disclosure is a heat management system. The heat management system includes a first channel, a second channel, a pump, and a supply apparatus. The first channel and the second channel are configured to flow the coolant inside. The pump connects the first channel and the second channel to each other. The pump is configured to deliver the coolant in the first channel to the second channel. The supply apparatus connects the first channel and the second channel to each other. The supply apparatus is configured to supply the coolant simultaneously to both the first channel and the second channel. The first channel includes a first device configured to exchange heat with the coolant when the coolant flows inside the first device. The second channel includes a second device configured to exchange heat with the coolant when the coolant flows inside the second device. When the supply apparatus simultaneously supplies the coolant to both the first channel and the second channel in a state where the coolant is not flowing through the first channel and the second channel, a pressure loss value of the coolant flowing toward the pump due to the second device is greater than a pressure loss value of the coolant flowing toward the pump due to the first device.

With the above configuration, because the channels for coolant in the heat management system are designed by focusing on the pressure loss values of the coolant in the devices, it is possible to suppress the reach of the coolant, supplied from the supply apparatus, to the pump through the second channel before the coolant reaches the pump through the first channel while suppressing the complexity of the channels for coolant. Then, it is possible to suppress the flow of the coolant inside the pump in reverse opposite to a direction in which the pump flows coolant. By extension, it is possible to suppress the generation of counter electromotive force due to the backflow of coolant inside the pump, so it is possible to suppress damage to the pump due to counter electromotive force.

Therefore, it is possible to suppress damage to the pump when coolant is supplied while suppressing the complexity of the channels for coolant.

In the heat management system according to the aspect of the disclosure, the first channel may further include a plurality of first pipes having elasticity. Each of the plurality of first pipes may connect two of the pump, the first device, and the supply apparatus to each other. The second channel may further include a plurality of second pipes having elasticity. Each of the plurality of second pipes may connect two of the pump, the second device, and the supply apparatus to each other.

With the above configuration, since the plurality of first pipes and the plurality of second pipes have elasticity, even when the volumes of the plurality of first pipes and the plurality of second pipes unintentionally change due to, for example, a reduction in the volumes of the plurality of first pipes and the plurality of second pipes caused by vacuuming in advance, it is possible to suppress the backflow of the coolant in the pump when the coolant is supplied while suppressing the complexity of the channels for the coolant by designing the channels based on the pressure loss values of the coolant in the devices.

In the heat management system according to the aspect of the disclosure, a volume of the second channel under normal pressure may be greater than a volume of the first channel under normal pressure.

With the above configuration, it is possible to further suppress the reach of the coolant, supplied from the supply apparatus, to the pump through the second channel before the coolant reaches the pump through the first channel.

In the heat management system according to the aspect of the disclosure, the second channel does not need to include a flow control valve configured to control a flow rate of the coolant flowing through the second channel.

Even when the second channel does not include a flow control valve at a predetermined position as in the case of the above configuration, it is possible to suppress damage to the pump when the coolant is supplied by designing the channels for the coolant in the heat management system based on the pressure loss values of the coolant in the devices. By extension, it is possible to provide a heat management system including relatively simple channels.

In the heat management system according to the aspect of the disclosure, the first channel does not need to include a coolant inlet that allows the coolant to be added into the first channel between the pump and the first device.

Even when the first channel does not include a coolant inlet at a predetermined position as in the case of the above configuration, it is possible to suppress damage to the pump due to the backflow of coolant when the coolant is supplied by designing the channels for the coolant in the heat management system based on the pressure loss values of the coolant in the devices. By extension, it is possible to provide a heat management system including relatively simple channels.

In the heat management system according to the aspect of the disclosure, the second device may include a high-pressure loss device. When the supply apparatus simultaneously supplies the coolant to both the first channel and the second channel in a state where the coolant is not flowing through the first channel and the second channel, a pressure loss value of the coolant flowing toward the pump in the high-pressure loss device may be the greatest between a pressure loss value of the coolant flowing toward the pump in the first device and a pressure loss value of the coolant flowing toward the pump in the second device.

With the above configuration, it is possible to design the channels based on the pressure loss values of coolant in the devices while increasing the flexibility of arrangement of the devices other than the high-pressure loss device, and, by extension, it is possible to provide a heat management system with relatively simple channels.

In the heat management system according to the aspect of the disclosure, the high-pressure loss device may be a power control unit that includes an inverter.

With the above configuration, except for the power control unit that has typically relatively complex channels for coolant, it is possible to design the channels based on the pressure loss values of the coolant in the devices while increasing the flexibility of arrangement of the devices, and by extension, it is possible to provide a heat management system with relatively simple channels.

In the heat management system according to the aspect of the disclosure, the supply apparatus may include a third channel and a multi-way valve. The third channel may include a second pump and a reservoir tank. The second pump may be configured to deliver the coolant in the third channel in one direction. The reservoir tank may be storing the coolant. The multi-way valve may be connected to the first channel, the second channel, and both ends of the third channel so as to flow the coolant being added to the reservoir tank and flowing out simultaneously to both the first channel and the second channel in a state where the coolant is not flowing through the first channel and the second channel.

Even in a heat management system with relatively complex channels where a plurality of circuits is connected via a multi-way valve and two pumps are provided, it is possible to suppress the backflow of coolant when the coolant is supplied while suppressing further complexity of the channels.

Another aspect of the disclosure is a manufacturing method for a heat management system. The manufacturing method includes reducing a pressure of air in a first channel and a second channel included in the heat management system from a supply apparatus included in the heat management system in a state where no coolant is flowing through the first channel and the second channel, and adding the coolant to the supply apparatus such that the supply apparatus simultaneously supplies the coolant to both the first channel and the second channel that are reduced in pressure. A pressure higher than atmospheric pressure is applied to the coolant.

Even in cases where the flow direction and flow rate of the coolant are difficult to be predicted when the coolant is supplied to the channels at a relatively high flow rate as in the case of the above configuration, when the channels are designed based on the pressure loss values of coolant in the devices, it is possible to provide a heat management system where the backflow of coolant in the pump is suppressed when the coolant is supplied while suppressing the complexity of channels for the coolant.

According to the aspects of the disclosure, it is possible to suppress damage to the pump when the coolant is supplied while suppressing the complexity of the channels for the coolant.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view that shows an example of a vehicle including a heat management system according to an embodiment of the disclosure;

FIG. 2 is a block diagram that shows an example of the configuration of the vehicle including the heat management system according to the embodiment of the disclosure;

FIG. 3 is a diagram that shows the overall configuration of the heat management system according to the embodiment of the disclosure;

FIG. 4 is a flowchart that shows a manufacturing method for the heat management system; and

FIG. 5 is a diagram that shows the heat management system in a state immediately after coolant is added.

### DETAILED DESCRIPTION OF EMBODIMENTS

Hereinafter, a heat management system according to an embodiment of the disclosure will be described with reference to the accompanying drawings. Like reference signs denote the same or corresponding portions in the drawings, and the description thereof will not be repeated.

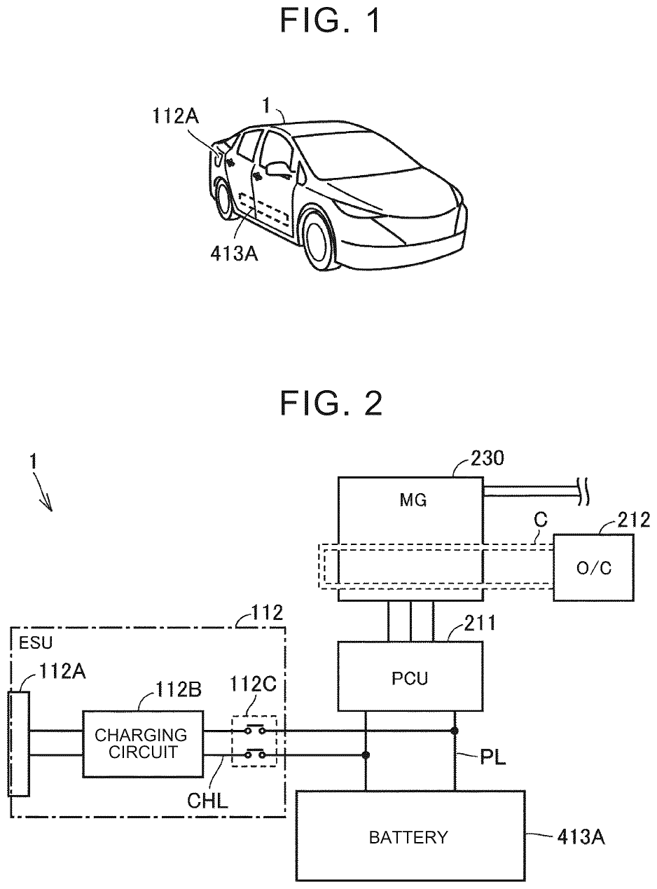

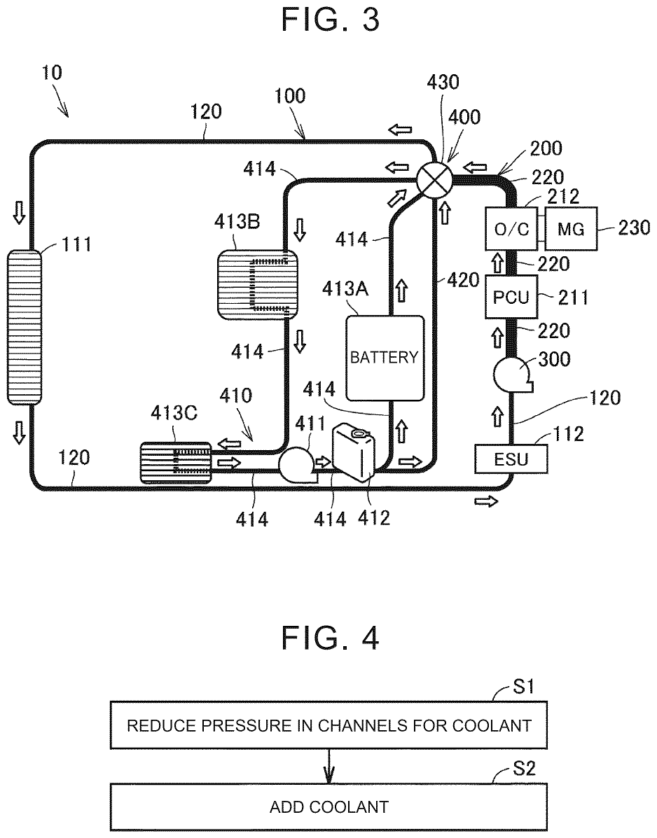

FIG. 1 is a perspective view that shows an example of a vehicle including the heat management system according to the embodiment of the disclosure. FIG. 2 is a diagram that shows an example of the configuration of the vehicle including the heat management system according to the embodiment of the disclosure. FIG. 3 is a diagram that shows the overall configuration of the heat management system according to the embodiment of the disclosure. As shown in FIG. 1 to FIG. 3, the heat management system 10 according to the embodiment of the disclosure is mounted on the vehicle 1. In other words, the vehicle 1 includes the heat management system 10. The vehicle 1 is an electrified vehicle (xEV). The details of the configuration of the vehicle 1 will be described later.

The heat management system 10 according to the embodiment of the disclosure will be described. As shown in FIG. 3, the heat management system 10 includes a first channel 100, a second channel 200, a pump 300 (first pump), and a supply unit 400.

The first channel 100 and the second channel 200 are configured to be able to flow coolant inside. In FIG. 3, the flow of the coolant is indicated by outline arrows. A liquid heat medium (for example, water or a coolant other than water) is used as the coolant. Examples of the coolant other than water include insulating oil and an antifreezing solution (for example, long life coolant (LLC)).

The first channel 100 includes one or more first devices 110 and a plurality of first pipes 120. In the present embodiment, the first channel 100 includes a plurality of first devices 110. The first channel 100 may include a single first device 110.

Each of the first devices 110 is configured to be able to exchange heat with coolant when the coolant flows inside the first device 110. In other words, when the coolant flows inside, the first device 110 may be cooled by the coolant, or the first device 110 may cool the coolant. Components that constitute the channel for the coolant inside the first device 110 substantially have no elasticity.

In the present embodiment, the first devices 110 include a radiator 111 and an electric supply unit (ESU) 112. The radiator 111 may cool or heat coolant flowing through the first channel 100 by, for example, exchanging heat with another thermal circuit. The ESU 112 includes, for example, an inlet 112A, a charging circuit 112B (on-board charger), and a charging relay 112C (see FIG. 2). These may be individually disposed as first devices 110.

Each of the first pipes 120 has elasticity. Each of the first pipes 120 connects two of the pump 300, the one or more first devices 110, and the supply unit 400 to each other. In the present embodiment, one of the first pipes 120 connects the pump 300 and one of the first devices 110 (specifically, the ESU 112) to each other. Another one of the first pipes 120 connects the supply unit 400 and the other one of the first devices 110 (specifically, the radiator 111) to each other. Further another one of the first pipes 120 connects the two first devices 110 (specifically the radiator 111 and the ESU 112) to each other. When the inlet 112A, the charging circuit 112B (on-board charger), and the charging relay 112C are individually the first devices 110 in the heat management system 10, two of them may be connected to each other by the first pipe 120.

The first channel 100 does not include a coolant inlet that allows coolant to be added to the first channel 100 between the pump 300 and the one or more first devices 110. The first channel 100 does not include a coolant inlet that allows coolant to be added to the first channel 100 as a whole.

The second channel 200 includes one or more second devices 210 and a plurality of second pipes 220. In the present embodiment, the second channel 200 includes a plurality of second devices 210. The second channel 200 may include a single second device 210.

Each of the second devices 210 is configured to be able to exchange heat with coolant when the coolant flows inside the second device 210. In other words, when the coolant flows inside, the second device 210 may be cooled by the coolant, or the second device 210 may cool the coolant. Components that constitute the channel for the coolant inside the second device 210 substantially have no elasticity. The one or more second devices 210 include a high-pressure loss device 211. In the present embodiment, the high-pressure loss device 211 is a power control unit (PCU) that includes an inverter. The details of the high-pressure loss device 211 will be described later. In the present embodiment, the second devices 210 further include an oil cooler 212.

Each of the second pipes 220 has elasticity. Each of the second pipes 220 connects two of the pump 300, the one or more second devices 210, and the supply unit 400 to each other. In the present embodiment, one of the second pipes 220 connects the pump 300 and one of the second devices 210 (specifically, the high-pressure loss device 211) to each other. Another one of the second pipes 220 connects the supply unit 400 and another one of the second devices 210 (specifically, the oil cooler 212) to each other. Further another one of the second pipes 220 connects the two second devices 210 (specifically, the high-pressure loss device 211 and the oil cooler 212) to each other.

The total length of the channel of all the second pipes 220 may be shorter than the total length of the channel of all the first pipes 120. However, the volume of the second channel 200 under normal pressure is greater than the volume of the first channel 100 under normal pressure. The second channel 200 does not include a flow control valve capable of controlling the flow rate of coolant flowing through the second channel 200. In other words, the high-pressure loss device 211 is a device different from a flow control valve.

The pump 300 is specifically a water pump. The pump 300 connects the first channel 100 and the second channel 200 to each other. The pump 300 is configured to be able to deliver coolant in the first channel 100 to the second channel 200. In other words, the pump 300 delivers the coolant in the first pipe 120 connected to the pump 300 to the second pipe 220 connected to the pump 300. In the present embodiment, the backflow of coolant in the pump 300 is suppressed when the coolant is supplied (described in detail later). The pump 300 itself does not need to include a diode or a fuse to stop the flow of current when an electromotive force is generated at the time when the coolant flows backward.

The supply unit 400 connects the first channel 100 and the second channel 200 to each other. The supply unit 400 is configured to be able to flow coolant, flowing in from the first channel 100, out to the second channel 200. Along with this, the supply unit 400 is configured to be able to supply coolant simultaneously to both the first channel 100 and the second channel 200 from outside the first channel 100 and the second channel 200.

Here, in the manufacturing method for the heat management system 10, which will be described in detail later, the supply unit 400 is caused to simultaneously supply coolant to both the first channel 100 and the second channel 200 in a state where no coolant is flowing through the first channel 100 and the second channel 200. At this time, the first channel 100 and the second channel 200 are designed such that the pressure loss value of coolant flowing toward the pump 300 due to the one or more second devices 210 is greater than the pressure loss value of coolant flowing toward the pump 300 due to the one or more first devices 110. The pressure loss value in one of the first devices 110 is the absolute value of the difference between the value of pressure of coolant supplied as described above on one side of the first device 110 in the first channel 100 and the value of pressure of coolant supplied as described above on the other side of the first device 110. The pressure loss value in one of the second devices 210 is the absolute value of the difference between the value of pressure of coolant supplied as described above on one side of the second device 210 in the second channel 200 and the value of pressure of coolant supplied as described above on the other side of the second device 210.

Furthermore, at this time, the second channel 200 is designed such that the pressure loss value of coolant flowing toward the pump 300 in the high-pressure loss device 211 is the greatest among the pressure loss values of the coolant flowing toward the pump 300 in the one or more first devices 110 and the one or more second devices 210. As described above, the high-pressure loss device 211 is specifically a power control unit (PCU) that includes an inverter. The PCU has a relatively complex structure that constitutes a channel for coolant, so the pressure loss of the coolant flowing inside the PCU also increases.

The supply unit 400 includes a third channel 410, a bypass channel 420, and a multi-way valve 430. The multi-way valve 430 is connected to both ends of the third channel 410. The third channel 410 includes a second pump 411, a reservoir tank 412, one or more third devices 413, and a plurality of third pipes 414.

The second pump 411 is specifically a water pump. The second pump 411 is configured to be able to deliver coolant in the third channel 410 in one direction. The reservoir tank 412 is storing coolant. The reservoir tank 412 is configured to allow addition of coolant. When coolant is added to the reservoir tank 412, the coolant is supplied to the third channel 410. The reservoir tank 412 is positioned on the side to which the second pump 411 delivers coolant in the third channel 410. Alternatively, the reservoir tank 412 may be disposed on the opposite side to the side to which the second pump 411 delivers coolant.

In the present embodiment, the third channel 410 includes a plurality of third devices 413. The third channel 410 may include a single third device 413. Each of the third devices 413 is configured to be able to exchange heat with coolant when the coolant flows inside the third device 413. In other words, when the coolant flows inside, the third device 413 may be cooled by the coolant, or the third device 413 may cool the coolant. Components that constitute the channel for the coolant inside the third device 413 substantially have no elasticity. In the present embodiment, the third devices 413 include a battery 413A, a chiller 413B, and a heat exchanger 413C. The chiller 413B and the heat exchanger 413C may cool or heat the coolant flowing through the third channel 410.

Each of the third pipes 414 has elasticity. Each of the third pipes 414 connects two of the second pump 411, the reservoir tank 412, the one or more third devices 413, and the multi-way valve 430 to each other. In the present embodiment, one of the third pipes 414 connects one port of the multi-way valve 430 and the chiller 413B to each other, another one of the third pipes 414 connects the chiller 413B and the heat exchanger 413C to each other, another one of the third pipes 414 connects the heat exchanger 413C and the second pump 411 to each other, another one of the third pipes 414 connects the second pump 411 and the reservoir tank 412 to each other, another one of the third pipes 414 connects the reservoir tank 412 and the battery 413A to each other, and the last one of the third pipes 414 connects the battery 413A and another port of the multi-way valve 430 to each other.

The bypass channel 420 branches off from the third channel 410 and connects to further another port of the multi-way valve 430. In the present embodiment, the bypass channel 420 includes a pipe having elasticity, and, specifically, the bypass channel 420 is made up of only a pipe having elasticity. In other words, the bypass channel 420 does not include any device intended to exchange heat with coolant flowing through the bypass channel 420. The bypass channel 420 may branch off from the third pipe 414 that connects the reservoir tank 412 to the battery 413A, or may be directly connected to the reservoir tank 412. For this reason, coolant added to the reservoir tank 412 is also supplied to the bypass channel 420.

The multi-way valve 430 is connected to one end of the first channel 100, one end of the second channel 200, both ends of the third channel 410, and one end of the bypass channel 420. Specifically, the multi-way valve 430 has five ports (not shown). The five ports are respectively connected to the first pipe 120, the second pipe 220, the two third pipes 414, and the pipe that makes up the bypass channel 420.

The multi-way valve 430 adjusts the flow rate of the coolant flowing in from each of the plurality of channels, or the flow rate of the coolant flowing out to each of the channels. In the present embodiment, the multi-way valve 430 adjusts the flow rate of coolant flowing in from the second channel 200 during the operation of the pump 300 and adjusts the flow rate of coolant flowing out to the first channel 100. For this reason, the multi-way valve 430 does not need to be able to close only any one of the port connected to the first channel 100 and the port connected to the second channel 200.

Next, an example of the configuration of the vehicle 1 will be described. As shown in FIG. 1 and FIG. 2, the vehicle 1 is configured to be able to drive using electric power output from the battery 413A. Specifically, the PCU 211 drives a motor generator (MG) 230 using electric power supplied from the battery 413A via a power supply line PL. The MG 230 functions as a drive motor and rotates the drive wheels of the vehicle 1. The oil cooler 212 cools lubricating oil in an oil circuit C using coolant flowing inside the oil cooler 212 in the second channel 200 (see FIG. 3). The oil circuit C supplies lubricating oil to the MG 230. The lubricating oil cools the MG 230. A system main relay (SMR) may be further provided in the power supply line PL.

The vehicle 1 is configured to be able to perform external charging (charge the battery 413A with electric power from outside the vehicle). The ESU 112 (the inlet 112A, the charging circuit 112B, and the charging relay 112C) is provided in a charging line CHL. When the connector of the charging cable connected to an electric vehicle supply equipment (EVSE) is connected to the inlet 112A of the vehicle 1 in a parked state, the vehicle 1 is electrically connected to the EVSE. The charging circuit 112B charges the battery 413A with electric power input from the EVSE to the inlet 112A. The charging relay 112C switches the status of the charging line CHL between a connected state and a disconnected state. The configuration of the vehicle 1 is not limited to the above.

Next, the manufacturing method for the heat management system 10 will be described. FIG. 4 is a flowchart that shows the manufacturing method for the heat management system. As shown in FIG. 4, the manufacturing method for the heat management system includes reducing the pressure in the channels for coolant (step S1) and adding coolant into the channels reduced in pressure (step S2) in this order.

Step S1 includes reducing the pressure of air inside the first channel 100, the second channel 200, the pump 300, and the supply unit 400 from the reservoir tank 412 of the supply unit 400 in a state where no coolant is flowing through the first channel 100, the second channel 200, the pump 300, and the supply unit 400 (see FIG. 3). In step S1, the insides of the first channel 100, the second channel 200, the pump 300, and the supply unit 400 are specifically evacuated from the reservoir tank 412.

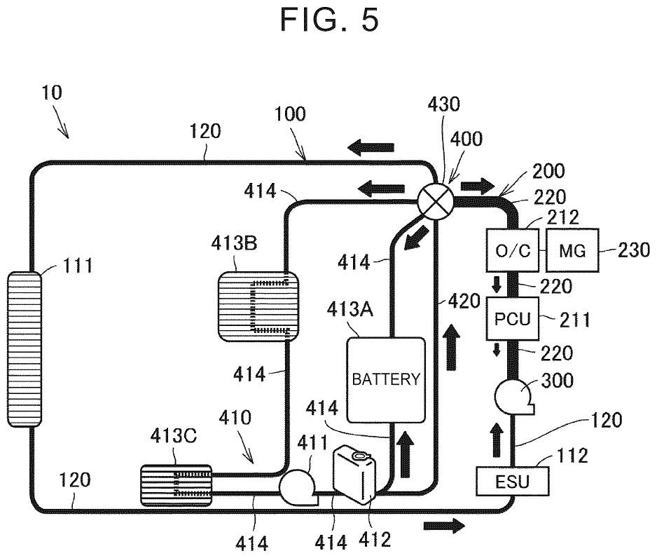

FIG. 5 is a diagram that shows the heat management system in a state immediately after coolant is added. In FIG. 5, the flow of coolant is indicated by thick arrows. As shown in FIG. 5, step S2 includes adding coolant, to which a pressure higher than atmospheric pressure is applied, into the reservoir tank 412 of the supply unit 400. Since the multi-way valve 430 has the configuration already described, the multi-way valve 430 flows coolant, flowing in by being added to the reservoir tank 412, out simultaneously to both the first channel 100 and the second channel 200. In the present embodiment, the coolant added to the reservoir tank 412 flows into the third pipe 414 and the bypass channel 420. Then, the coolant in the bypass channel 420 first flows into the multi-way valve 430. This is because no device intended for heat exchange is disposed in the bypass channel 420. In the manufacturing method according to the present embodiment, the multi-way valve 430 is in a state where all the ports are open. Thus, coolant quickly spreads to the channels. Therefore, coolant flowing from the bypass channel 420 into the multi-way valve 430 flows into the first channel 100, the second channel 200, and the third channel 410. As a result, the supply unit 400 simultaneously supplies coolant to both the first channel 100 and the second channel 200 reduced in pressure.

Then, as described above, the first channel 100 and the second channel 200 are designed such that the pressure loss value of coolant flowing toward the pump 300 due to the one or more second devices 210 is greater than the pressure loss value of coolant flowing toward the pump 300 due to the one or more first devices 110. In other words, the first channel 100 and the second channel 200 are designed such that the total of the pressure loss value of coolant flowing toward the pump 300 in the one or more second devices 210 is greater than the total of the pressure loss value of coolant flowing toward the pump in the one or more first devices 110. As a result, the coolant supplied from the supply unit 400 reaches the pump 300 through the first channel 100 before reaching the pump 300 through the second channel 200. Specifically, the first channel 100 and the second channel 200 are designed such that the total of the pressure loss values of coolant flowing toward the pump 300 in all the second devices 210 is greater than the total of the pressure loss values of coolant flowing toward the pump in all the first devices 110.

By adding the coolant to the heat management system 10 as described above, the heat management system 10 is manufactured.

As described above, the heat management system 10 according to the embodiment of the disclosure includes the first channel 100, the second channel 200, the pump 300, and the supply unit 400. The first channel 100 and the second channel 200 are configured to be able to flow coolant inside. The pump 300 connects the first channel 100 and the second channel 200 to each other. The pump 300 is configured to be able to deliver coolant in the first channel 100 to the second channel 200. The supply unit 400 connects the first channel 100 and the second channel 200 to each other. The supply unit 400 is configured to be able to simultaneously supply coolant to both the first channel 100 and the second channel 200. The first channel 100 includes one or more first devices 110 configured to be able to exchange heat with coolant when the coolant flows inside the first device 110. The second channel 200 includes one or more second devices 210 configured to be able to exchange heat with coolant when the coolant flows inside the second device 210. When the supply unit 400 simultaneously supplies coolant to both the first channel 100 and the second channel 200 in a state where no coolant is flowing through the first channel 100 and the second channel 200, the pressure loss value of coolant flowing toward the pump 300 due to one or more second devices 210 is greater than the pressure loss value of coolant flowing toward the pump 300 due to one or more first devices 110.

With the above configuration, because the channels for coolant in the heat management system 10 are designed by focusing on the pressure loss values of coolant in the devices, it is possible to suppress the reach of coolant, supplied from the supply unit 400, to the pump 300 through the second channel 200 before coolant reaches the pump 300 through the first channel 100 while suppressing the complexity of the channels for coolant. Then, it is possible to suppress the flow of coolant inside the pump 300 in reverse opposite to a direction in which the pump 300 flows coolant. By extension, it is possible to suppress the generation of counter electromotive force due to the backflow of coolant inside the pump 300, so it is possible to suppress damage to the pump 300 due to counter electromotive force.

Therefore, it is possible to suppress damage to the pump 300 when coolant is supplied while suppressing the complexity of the channels for coolant.

In the present embodiment, the first channel 100 further includes the plurality of first pipes 120 having elasticity. Each of the first pipes 120 connects two of the pump 300, the one or more first devices 110, and the supply unit 400 to each other. The second channel 200 further includes the plurality of second pipes 220 having elasticity. Each of the second pipes 220 connects two of the pump 300, the one or more second devices 210, and the supply unit 400 to each other.

With the above configuration, even when the first pipes 120 have elasticity and are deformed unintentionally to increase their volumes, or the second pipes 220 have elasticity and are deformed unintentionally to reduce their volumes, it is possible to suppress the backflow of coolant in the pump 300 when coolant is supplied while suppressing the complexity of the channels for coolant by designing the channels based on the pressure loss values of coolant in the devices.

In the present embodiment, the volume of the second channel 200 under normal pressure is greater than the volume of the first channel 100 under normal pressure.

With the above configuration, it is possible to further suppress the reach of coolant, supplied from the supply unit 400, to the pump 300 through the second channel 200 before the coolant reaches the pump 300 through the first channel 100.

In the present embodiment, the second channel 200 does not include a flow control valve capable of controlling the flow rate of coolant flowing through the second channel 200.

Even when the second channel 200 does not include a flow control valve at a predetermined position as in the case of the above configuration, it is possible to suppress damage to the pump 300 when coolant is supplied by designing the channels for coolant in the heat management system 10 based on the pressure loss values of coolant in the devices. By extension, it is possible to provide the heat management system 10 including relatively simple channels.

In the present embodiment, the first channel 100 does not include a coolant inlet that allows coolant to be added to the first channel 100 between the pump 300 and the one or more first devices 110.

Even when the first channel 100 does not include a coolant inlet at a predetermined position as in the case of the above configuration, it is possible to suppress damage to the pump 300 due to the backflow of coolant when coolant is supplied by designing the channels for coolant in the heat management system 10 based on the pressure loss values of coolant in the devices. By extension, it is possible to provide the heat management system 10 including relatively simple channels.

In the present embodiment, the one or more second devices 210 include the high-pressure loss device 211. When the supply unit 400 simultaneously supplies coolant to both the first channel 100 and the second channel 200 in a state where no coolant is flowing through the first channel 100 and the second channel 200, the pressure loss value of coolant flowing toward the pump 300 in the high-pressure loss device 211 is the greatest among the pressure loss values of coolant flowing toward the pump 300 in the one or more first devices 110 and the one or more second devices 210.

With the above configuration, it is possible to design the channels based on the pressure loss values of coolant in the devices while increasing the flexibility of arrangement of the devices other than the high-pressure loss device 211, and, by extension, it is possible to provide the heat management system 10 with relatively simple channels.

In the present embodiment, the high-pressure loss device 211 is a power control unit that includes an inverter.

With the above configuration, except for the power control unit that has typically relatively complex channels for coolant, it is possible to design the channels based on the pressure loss values of coolant in the devices while increasing the flexibility of arrangement of the devices, and by extension, it is possible to provide the heat management system 10 with relatively simple channels.

In the present embodiment, the supply unit 400 includes the third channel 410 and the multi-way valve 430. The third channel 410 includes the second pump 411 and the reservoir tank 412. The second pump 411 is configured to be able to deliver coolant in the third channel 410 in one direction. The reservoir tank 412 is storing coolant. The multi-way valve 430 is connected to the first channel 100, the second channel 200, and both ends of the third channel 410 so as to be able to flow coolant, flowing in by being added to the reservoir tank 412, out simultaneously to both the first channel 100 and the second channel 200 in a state where no coolant is flowing through the first channel 100 and the second channel 200.

Even in the heat management system 10 with relatively complex channels where a plurality of circuits is connected via the multi-way valve 430 and the two pumps 300 are provided, it is possible to suppress the backflow of coolant in the pump 300 when coolant is supplied while suppressing further complexity of the channels.

The manufacturing method for the heat management system 10 according to the present embodiment includes reducing the pressure of air inside the first channel 100 and the second channel 200 from the supply unit 400 in a state where no coolant is flowing through the first channel 100 and the second channel 200, and adding coolant, to which a pressure higher than atmospheric pressure is applied, to the supply unit 400 such that the supply unit 400 simultaneously supplies coolant to both the first channel 100 and the second channel 200 reduced in pressure.

With the above configuration, coolant flows relatively vigorously through the first channel 100 and the second channel 200. As a result, it is possible to reduce the cycle time of a step of adding coolant when the heat management system 10 is manufactured. By supplying coolant in this manner, even when the flow direction and flow rate of coolant in the channels of the heat management system 10 are difficult to be predicted, when the channels are designed based on the pressure loss values of coolant in the devices, it is possible to provide the heat management system 10 with which the backflow of coolant in the pump 300 is suppressed when coolant is supplied while suppressing the complexity of the channels for coolant.

In the description of the embodiment, a combination of components is possible.

The embodiment described above is illustrative and not restrictive in all respects. The scope of the disclosure is not defined by the description of the above-described embodiment, and is defined by the appended claims. The scope of the disclosure is intended to encompass all modifications within the scope of the appended claims and equivalents thereof.

What is claimed is:

1. A heat management system comprising:
a first channel;
a second channel;
a pump; and
a supply apparatus, wherein
the first channel and the second channel are configured to allow coolant to flow inside,
the pump connects the first channel and the second channel to each other and is configured to deliver the coolant in the first channel to the second channel,
the supply apparatus connects the first channel and the second channel to each other and is configured to supply the coolant simultaneously to both the first channel and the second channel,
the first channel includes a first device configured to exchange heat with the coolant when the coolant flows inside the first device,
the second channel includes a second device configured to exchange heat with the coolant when the coolant flows inside the second device, and
when the supply apparatus simultaneously supplies the coolant to both the first channel and the second channel in a state where the coolant is not flowing through the first channel and the second channel, a pressure loss value of the coolant flowing toward the pump due to the second device is greater than a pressure loss value of the coolant flowing toward the pump due to the first device.

2. The heat management system according to claim 1, wherein:
the first channel further includes a plurality of first pipes having elasticity;
each of the plurality of first pipes connects two of the pump, the first device, and the supply apparatus to each other;
the second channel further includes a plurality of second pipes having elasticity; and
each of the plurality of second pipes connects two of the pump, the second device, and the supply apparatus to each other.

3. The heat management system according to claim 1, wherein a volume of the second channel under normal pressure is greater than a volume of the first channel under normal pressure.

4. The heat management system according to claim 1, wherein the second channel does not include a flow control valve configured to control a flow rate of the coolant flowing through the second channel.

5. The heat management system according to claim 1, wherein the first channel does not include a coolant inlet that allows the coolant to be added into the first channel between the pump and the first device.

6. The heat management system according to claim 1, wherein:
the second device includes a high-pressure loss device; and
when the supply apparatus simultaneously supplies the coolant to both the first channel and the second channel in a state where the coolant is not flowing through the first channel and the second channel, a pressure loss value of the coolant flowing toward the pump in the high-pressure loss device is the greatest between a pressure loss value of the coolant flowing toward the pump in the first device and a pressure loss value of the coolant flowing toward the pump in the second device.

7. The heat management system according to claim 6, wherein the high-pressure loss device is a power control unit that includes an inverter.

8. The heat management system according to claim 1, wherein:
the supply apparatus includes a third channel and a multi-way valve;
the third channel includes a second pump and a reservoir tank;
the second pump is configured to deliver the coolant in the third channel in one direction;
the reservoir tank is storing the coolant; and
the multi-way valve is connected to the first channel, the second channel, and both ends of the third channel so as to flow the coolant being added to the reservoir tank and flowing out simultaneously to both the first channel and the second channel in a state where the coolant is not flowing through the first channel and the second channel.

9. A manufacturing method for a heat management system, the manufacturing method comprising:
reducing a pressure of air in a first channel and a second channel included in the heat management system from a supply apparatus included in the heat management system in a state where no coolant is flowing through the first channel and the second channel, wherein the first channel and the second channel are configured to flow the coolant inside; and
adding the coolant to the supply apparatus such that the supply apparatus simultaneously supplies the coolant to both the first channel and the second channel that are reduced in pressure, a pressure higher than atmospheric pressure being applied to the coolant.
